(19) United States
(12) Patent Application Publication
(10) Pub. No.: US 2025/0367685 A1
(43) Pub. Date: Dec. 4, 2025

(54) Spraying Bowl for Liquid Coating Product, Rotary Sprayer Comprising Such a Bowl and Process for Applying a Coating Product With Such a Sprayer

(71) Applicant: EXEL INDUSTRIES, Epernay (FR)

(72) Inventors: David VINCENT, Epernay (FR); Sylvain PERINET, Epernay (FR); Benoit-Marc VEDOVATI, Epernay (FR)

(21) Appl. No.: 19/220,353

(22) Filed: May 28, 2025

(30) Foreign Application Priority Data
May 28, 2024 (FR) 2405459

(51) Int. Cl. B05B 3/10; B05D 1/04

(52) U.S. Cl. CPC B05B 3/1014; B05B 3/1035; B05D 1/04

(57) ABSTRACT

The present invention relates to a spraying bowl for liquid coating product, intended to be incorporated into a rotary coating product sprayer and comprising a body centred on a longitudinal axis and which defines a radial internal surface for distributing the coating product as far as a circular spraying edge centred on the longitudinal axis and equipped with notches formed in the radial internal distribution surface and evenly distributed around its circumference. The linear density of the notches along the circular spraying edge is greater than or equal to 4 notches per millimetre. An opening angle of each notch is less than or equal to 45°.

### CROSS-REFERENCE TO RELATED APPLICATIONS

This application claims priority to French Application No. 2405459, filed on May 28, 2024, which is incorporated herein by reference in its entirety.

### BACKGROUND OF THE INVENTION

This invention relates to a spraying bowl for liquid coating product, for incorporation into a rotary coating sprayer. The present invention further relates to a rotary sprayer comprising such a bowl, and to a process of applying a coating product by means of such a rotary sprayer.

In the field of spraying liquid coating product, it is known to use a rotary sprayer equipped with a spraying member, usually called a bowl, which defines a distribution surface for the coating product up to a circular spraying edge, from which drops of coating product are sprayed.

Such a spraying bowl is known, for example, from WO 03/074187A1. Such a bowl can be made with notches in the vicinity of its circular spraying edge. This notching process homogenises and refines the drops leaving the circular spraying edge of the bowl.

Another spraying bowl is known from U.S. Pat. No. 4,519,549. The bowl has cut-outs along its circumferential edge, forming a saw-tooth structure.

With known notched bowls, i.e. bowls made with notches that form a notch near, or along, their circular spraying edge, the atomisation of paint drops and their homogeneity are relatively well-controlled. The speed of rotation of the bowl refines the drops of coating product. The higher the speed, the finer the drops.

On the other hand, a drop of coating product leaves the edge of the bowl with a kinetic energy that is greater when the speed of rotation of the bowl is faster. However, the direction at which the drops of coating product are ejected from the edge of the bowl is generally perpendicular to the axis of rotation of the bowl. The drops of coating product must therefore be directed towards the object to be coated, for example a motor vehicle body. In this case, it is known to use a shaping skirt equipped with shaping air outlet orifices, this shaping air having an aeraulic effect directed in a generally axial direction with respect to the axis of rotation of the bowl, which enables the paint drops to be forced back towards the object to be coated. In addition, in the case of an electrostatic sprayer, an electrostatic charge applied to the coating product before or after spraying enables the electrostatic effect to be used to direct the drops of coating product towards the object to be coated. The higher the speed of rotation of the bowl, the more the kinetic energy of the drops leaving the edge of the bowl must be compensated for, by means of the shaping air and possibly the electrostatic effect, to force the drops of coating product back towards the object to be coated.

A recurring problem with rotary coating product atomisers is that the aim is to increase the yield, i.e. the proportion of coating product actually deposited on the object to be coated, without reducing the quality of the layer of coating product deposited.

In this context, it may be possible to reduce the speed of rotation of the bowl in order to reduce the kinetic energy of the drops leaving its edge. However, in this case, even with a notched bowl, there is a risk of reducing the homogeneity of the cloud of drops leaving the edge of the bowl and of increasing the size of these drops, which is likely to degrade the quality of the layer of coating product applied.

### BRIEF SUMMARY OF THE INVENTION

These problems are specifically addressed by the invention, which proposes a new spraying bowl for liquid coating product that enables coating product to be applied efficiently and with good quality, even when the bowl is at a relatively low speed of rotation.

To this end, the invention relates to a spraying bowl for liquid coating product, intended to be incorporated into a rotary coating product sprayer and comprising a body centred on a longitudinal axis and which defines a radial internal surface for distributing the coating product as far as a circular spraying edge centred on the longitudinal axis and equipped with notches formed in the radial internal distribution surface and evenly distributed around its circumference. In accordance with the invention, the linear density of notches along the circular spraying edge is greater than or equal to 4 notches per millimetre and an opening angle of each notch is less than or equal to 45°.

Thanks to the invention, the combination of the features of the notching obtained by the notches distributed around the circumference of the circular edge, both in terms of linear density and opening angle, has the effect that a relatively large quantity of coating product can be sprayed from the edge of the bowl with good homogeneity of the drops which are fine, i.e. of a size adapted to the creation of a layer of coating product, while the speed of rotation of the bowl can be relatively low. In particular, the above-mentioned features of the notching run counter to the habits of the person skilled in the art, who tends rather to use notches with large opening angles, of the order of 90° or more, believing that this allows the creation of channels of large cross-section for the circulation of threads of coating product inside the notches of the bowl. The present invention takes the opposite approach, wherein the number of notches is substantially increased compared to known bowl notches, while the opening angle of each notch is reduced.

According to advantageous but not mandatory aspects of the invention, such a bowl may incorporate one or more of the following features, taken in any combination that is technically feasible:
The maximum depth of each notch, measured in a direction radial to the longitudinal axis, is greater than or equal to 0.1 mm, preferably greater than or equal to 0.2 mm.
All the notches are straight and parallel to each other.

A diameter of the circular spraying edge is less than or equal to 80 mm, preferably equal to about 65 mm.
The opening angle of each notch is less than or equal to 30°, preferably about 20°.
A radial thickness of the circular spraying edge measured perpendicular to the longitudinal axis, between the bottom of a notch and a radial outer surface of the bowl, is between 0.2 and 0.5 mm, preferably between 0.3 and 0.4 mm.

According to a second aspect, the invention relates to a coating product sprayer comprising a body defining an axis of rotation; a coating product spraying bowl rotating about the axis of rotation; a turbine for rotating the bowl about the axis of rotation; and an air skirt equipped with shaping air outlet orifices. In accordance with the invention, the coating product spraying bowl is as described above, with its longitudinal axis aligned with the axis of rotation.

According to a third aspect, the invention relates to a process for applying a liquid coating product by means of a sprayer as described above, wherein the bowl is rotated by the turbine, about the axis of rotation, at a speed of rotation of less than or equal to 40000 rpm, preferably at 30000 rpm, and the shaping air outlet orifices are supplied with shaping air at a flow rate of between 250 and 500 L/min, preferably between 300 and 450 L/min.

Advantageously, the sprayer comprises means for applying a high voltage to the product being applied and wherein the high voltage applied is between 40 and 85 KV, preferably between 45 and 60 kV.

According to another advantageous aspect, the product applied according to the process of the invention is a primer or a varnish.

### BRIEF DESCRIPTION OF THE DRAWINGS

The invention will be better understood and its other advantages will become more apparent in the light of the following description of an embodiment of a spraying bowl, a rotary coating product sprayer, and an application process complying with its principle, in accordance with its principle, given by way of example only and with reference to the drawings.

FIG. 1 is a principle partial longitudinal section of a rotary coating product sprayer according to the invention, incorporating a bowl also in accordance with the invention.

FIG. 2 shows, on two inserts A) and B), two partial views of the sprayer bowl of FIG. 1, insert A) corresponding to detail II on FIG. 1, on a larger scale, and insert B) corresponding to a partial section along line B-B on insert A, also on a larger scale.

### DETAILED DESCRIPTION OF THE INVENTION

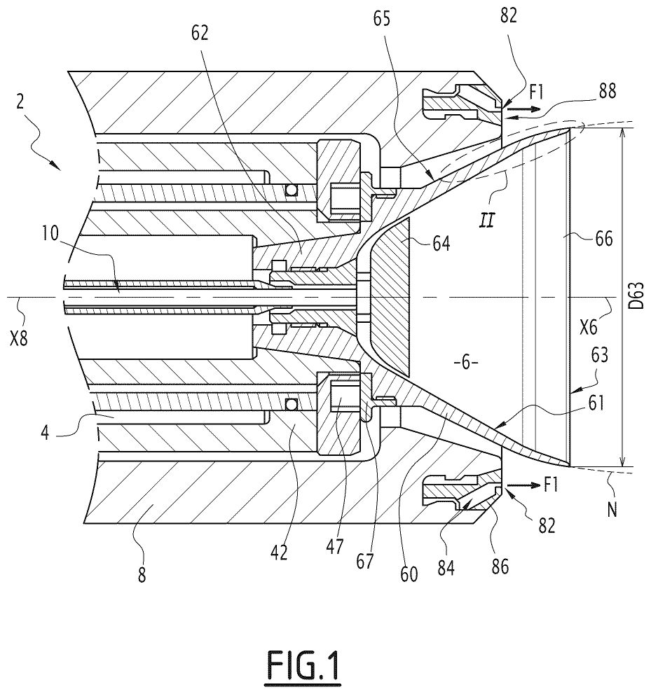

A rotary liquid coating product sprayer 2, a front part of which is shown in cross-section in FIG. 1, comprises a turbine 4 for rotating a spraying member 6, referred to hereafter as a bowl, about an axis X8 defined by a body 8 of the sprayer 2.

The sprayer 2 is of the electrostatic type and comprises means for applying high voltage to a coating product being sprayed with the sprayer 2, for example a high-voltage cascade and an electrical link between this cascade and the bowl 6, not shown.

Alternatively, the sprayer 2 is non-electrostatic.

The bowl 6 is supplied with liquid coating product via an axial conduit 10 centred on the axis X8 and which opens into a hub 62 of the bowl 6. The bowl comprises a one-piece body 60 which defines an inner radial surface 61 and an outer radial surface 65, relative to a longitudinal axis X6 of this bowl, which is coincident with the axis X8 when the bowl 6 is mounted on the turbine 4. The bowl 6 is equipped with a distributor 64 which makes it possible to return the coating product coming from the conduit 10 in the direction of the internal radial surface 61 on which this product is distributed, the downstream end of which forms a circular spraying edge 63 of a cloud N of drops of coating product, during the operation of the sprayer 2. The function of the surface 61, which is centred on the longitudinal axis X6, is to distribute the coating product coming from the conduit 10 evenly and with decreasing thickness along the axis X6 as it approaches the circular spraying edge 63.

Along the longitudinal axis X6, the surface 65 also extends as far as the circular spraying edge 63.

Surfaces 61 and 65 and edge 63 are centred on the longitudinal axis X6.

The diameter of the circular spraying edge 63 is denoted D63. Advantageously, the diameter D63 is less than or equal to 80 millimetres (mm), for example around 65 mm in the embodiment shown in the figures. “Around 65 mm” means 65 mm to the nearest 1 mm. This relatively modest value for the diameter D63 means that, for a given speed of rotation of the bowl 6, the tangential ejection speed of the drops of coating product is not too high, which means that the distribution of the drops in the cloud N can be controlled.

In the example shown, the bowl 6, in particular its body 60, is made of an aluminium-based alloy.

Alternatively, the bowl can be made of titanium or a titanium-based alloy. Other materials are also possible for the bowl 6, for example a magnesium alloy or a non-metallic material such as a thermoplastic, thermoset or ceramic.

In the present description, upstream corresponds to a direction facing the source of the coating product or cleaning product sprayed when the sprayer 2 is operating, on the left of FIG. 1, while downstream corresponds to an opposite direction, facing the circular spraying edge 63, on the right in this figure.

The rotor 42 of the turbine 4 and the bowl 6 can be made to rotate together by magnetic attraction, in particular by means of a magnet 47 integrated into this rotor and a ferromagnetic ring 67 integrated into the bowl 6, at its external radial surface 65.

Alternatively, other means of causing the rotor 42 to the bowl 6 to rotate together can be used, such as by screwing.

The body 8 is equipped with an air skirt 86 which defines orifices 82 for ejecting shaping air intended to guide or shape the cloud N of drops of coating product leaving the edge 63 in the direction of an object to be coated (not shown). In FIG. 1, the jets of air leaving the orifices 82 are represented by the arrows F1. In practice, the orifices 82 are evenly spaced around the axis X8, with an angular spacing of between 2° and 15°.

When the sprayer 2 is operating, the orifices 82 are supplied with pressurised air via ducts 84 in the air skirt 86.

The orifices 82 open onto an annular surface of the body 2 which forms a ring 88 surrounding the axis X8 and the bowl 6 when the latter is mounted in the sprayer 2. The ring 88 forms the front face of the body 8, i.e. its end face facing the object to be coated while the sprayer 2 is in operation.

The circular spraying edge 63 is equipped, on its inner side facing the longitudinal axis X66, with a notching 66 formed by a succession of notches 66₁, 66₂, 66₃ . . . 66ᵢ . . . which are regularly distributed around the axis X6. The notching 66 is formed in the portion of the distribution surface 61 that joins the edge 63. In the following, 66ᵢ, where i is a natural number, refers to one of the notches in the notching 66.

The notches 66, are identical to each other around the entire circumference of the edge 63.

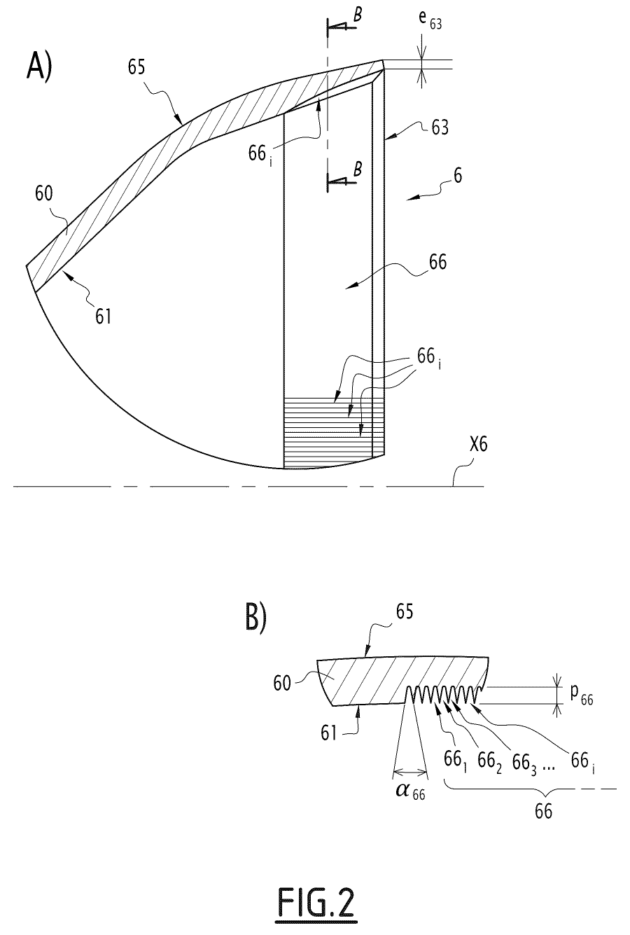

In insert B) in FIG. 2, the notching 66 is shown on only part of the figure, on the right, so that the distribution surface 61, on the left, can be seen. In practice, the notching extends around the entire circumference of the circular spraying edge 63.

All the notches 66ᵢ of the notching 66 are straight, parallel to the axis X6 and parallel to each other. According to an unrepresented variant of the invention, the notches 66ᵢ are not parallel to the axis X6, while all having the same angle of inclination with respect to the axis X6 and being parallel to each other. In all cases, therefore, notching 66 is not a knurling formed by the crossing of notches oriented in different directions. The dimensions of notching 66 are easier to control than those of knurling.

e₆₃ is the minimum radial thickness of the circular spraying edge 63, measured between the bottom of a notching 66ᵢ and the radial outer surface 65. The thickness e₆₃ is measured radially to the longitudinal axis X6. This minimum radial thickness e₆₃ is chosen to be between 0.2 and 0.5 mm, preferably between 0.3 and 0.4 mm. In the example shown, this radial thickness e₆₃ is equal to 0.35 mm.

The value of the radial thickness e₆₃ gives the bowl 6 good geometric stability, even when it is subjected to relatively high centrifugal forces when the turbine 4 rotates the bowl 6 about the axes X6 and X8 together. The radial thickness e₆₃ therefore makes it possible to guarantee the dimensional stability of the notching 66, and therefore the homogeneity and regularity of the paint drops leaving the circular spraying edge 63, even in the event of variations in the speed of rotation of the bowl 6.

The length L63 of the circular spraying edge 63 is equal to this diameter minus twice the radial thickness e₆₃ and multiplied by π as set forth in the equation 1 below:

L63=(D63−2*e₆₃)*π (equation 1)

If the diameter D63 is 65 mm, the length L63 of the circular spraying edge 63 is approximately 204 mm.

In the example shown in the figures, the number of notches 66ᵢ in notching 66 is 1200.

The linear density DL₆₆ of the notches 66ᵢ along the circular spraying edge 63 is defined as the number of notches 66ᵢ of the notching 66 per millimetre of circumference of the edge 63.

In the example, the linear density DL₆₆ of the notches 66ᵢ of the notching 66 is:

DL₆₆=1200/204=5.88 notches/mm (equation 2)

Satisfactory tests were carried out with notchings 66 comprising a number of notches greater than or equal to 1050 for a bowl whose circular spraying edge has a diameter of the order of 65 mm. Thus, a linear density DL₆₆ of at least 4 notches per mm makes it possible to obtain satisfactory results in terms of the distribution and fineness of the drops in the cloud N.

In practice, the linear density DL₆₆ of the notches 66ᵢ of the notching 64 can be controlled by varying the number of notches 66ᵢ of this notching 66 and the diameter D63 of the edge 63, over a range of spraying bowls, while respecting the condition DL₆₆≥4 notches/mm.

An opening angle α₆₆ of a notching 66ᵢ is defined as the angle formed between two flat surfaces constituting the sides of this notching 66ᵢ. As the notches 66ᵢ are identical around the entire circumference of the edge 63, the angle α₆₆ is constant around this circumference.

In a variant not shown, the surfaces forming the sides of the notches 66ᵢ are not flat. In this case, the opening angle α₆₆ of a notch is defined as an average angle between these surfaces.

In the example shown, the angle α₆₆ is approximately 20°, i.e. 20° to the nearest 0.5°. This value of the angle α₆₆ allows the notches 66ᵢ to be placed with a high linear density, which makes it possible to distribute the coating product from the edge 63 with a sufficient flow rate to ensure effective coating with the bowl 6.

Alternatively, the angle α₆₆ can have a value greater than 20°, while remaining less than or equal to 45°, preferably less than or equal to 30°.

As can be seen from insert A) in FIG. 2, the radial depth of a notching 66ᵢ is variable along its length, taken parallel to the longitudinal axis X6. p₆₆ is the maximum depth of a notching 66ᵢ in the notching 66, measured perpendicular to the longitudinal axis X66.

This maximum depth p₆₆ is chosen to be greater than or equal to 0.1 mm, preferably greater than or equal to 0.2 mm. This maximum depth p₆₆ gives each notch sufficient volume to receive, during application, a quantity of coating product required to produce the cloud N.

The geometry of the notches 66ᵢ is compatible with an application of coating product under industrial conditions insofar as the linear density DL₆₆ of the notches 66ᵢ of the notching 66, distributed along the circular spraying edge 63, makes it possible to distribute a relatively large flow of coating product, even though the opening angle α₆₆ of these notches 66ᵢ is relatively small. In this respect, the invention goes against the standard reasoning of the person skilled in the art, who would tend instead to increase the opening angle α₆₆ to enable a greater flow rate of coating product to be distributed at the circular spraying edge 63, in order to create the cloud N of drops.

The structure of the notching 66 on the bowl 6 mentioned above means that it can be used as part of a coating product application process during which the bowl 6 is rotated by the turbine 4 about the axes X6 and X8 together, at a relatively low speed of rotation, less than or equal to 40,000 revolutions per minute (rpm), preferably 30,000 rpm. This ensures that the drops of coating product leaving the circular spraying edge 63 have a moderate kinetic energy. In this case, the aeraulic force due to the shaping air and, if necessary, the electrostatic force due to the electrostatic field, enable the paint drops to be folded more effectively towards the part to be coated.

In this case, the air outlets 82 are advantageously supplied with shaping air at a flow rate of between 250 and 500 litres per minute (L/min), preferably between 300 and 450 l/min. The flow rate to the outlets 82 can also be expressed in normal litres per minute (NLPM), with values close to those mentioned above. This also makes it possible to reduce the shaping air flow rate compared with known coating product application processes.

In the case where the sprayer 2 is of the electrostatic type, as in the example shown in the figures, the cascade or any other means of applying a high voltage to the coating product being sprayed are capable of applying a high voltage of between 40 and 85 kilovolts (kV), preferably between 45 and 60 kV since the distance between the circular spraying edge 63 of the bowl 6 and the surface to be coated is small, for example less than or equal to 180 mm, preferably less than or equal to 150 mm and advantageously less than or equal to 100 mm.

Advantageously, the coating product sprayed with the bowl 6 as part of the application process of the invention is a primer or a varnish. The composition of a primer or varnish is not disturbed by passing through a notch such as the notching 66, whereas a base might be. The homogeneity and size of the cloud of drops leaving the edge of the bowl 6 after passing through a notch such as notching 66, during the application of a primer or a varnish, is not degraded, even at a relatively low speed of rotation, whereas a base might be.

Any feature described for one embodiment or variant in the foregoing may be implemented for one or more other embodiments and variants mentioned above, insofar as is technically feasible.

1. A spraying bowl for a liquid coating product, wherein the spraying bowl is to be incorporated into a rotary coating product sprayer, the spraying bowl comprising a body centred on a longitudinal axis and which defines a radial internal surface for distributing the coating product as far as a circular spraying edge centred on the longitudinal axis and equipped with notches formed in the radial internal surface and evenly distributed around its circumference, wherein:
the notches have a linear density along the circular spraying edge that is greater than or equal to 4 notches per millimetre; and
each notch has an opening angle that is less than or equal to 45°.

2. The spraying bowl of claim 1, wherein a maximum depth of each notch, measured in a direction radial to the longitudinal axis, is greater than or equal to 0.1 mm.

3. The spraying bowl of claim 1, wherein all the notches are rectilinear and parallel to one another.

4. The spraying bowl of claim 1, wherein a diameter of the circular spraying edge is less than or equal to 80 mm.

5. The spraying bowl of claim 1, wherein the opening angle of each notch is less than or equal to 30°.

6. The spraying bowl of claim 1, in which a radial thickness of the circular spraying edge measured perpendicularly to the longitudinal axis, between the bottom of a notch and a radial outer surface of the bowl, is between 0.2 and 0.5 mm.

7. A rotary coating product sprayer comprising:
a body defining an axis of rotation;
a bowl for spraying coating product, rotating about the axis of rotation;
a turbine to rotate the bowl about the axis of rotation; and
an air skirt equipped with shaping air outlet orifices;
wherein the bowl for spraying coating product is according to claim 1, with its longitudinal axis aligned with the axis of rotation.

8. A process for applying liquid coating product by means of a sprayer according to claim 7, the process comprising:
rotating the bowl by the turbine, about the axis of rotation, at a speed of rotation less than or equal to 40,000 rpm; and
supplying the shaping air outlet orifices shaping air at a flow rate of between 250 and 500 L/min.

9. The process of claim 8, further comprising applying a high voltage between 40 and 85 kV to the product being applied with the sprayer, which further comprises means for applying a high voltage to the product being applied.

10. The process of claim 8, wherein the applied coating product is a primer or a varnish.
